(19) United States
(12) Patent Application Publication
(10) Pub. No.: US 2025/0110792 A1
(43) Pub. Date: Apr. 3, 2025

(54) Task Graph Submission for Scalable Input/Output Virtualization (SIOV) Devices

(71) Applicant: Advanced Micro Devices, Inc., Santa Clara, CA (US)

(72) Inventors: Stephen Alexander Zekany, Redmond, WA (US); Anthony Thomas Gutierrez, Seattle, WA (US)

(73) Assignee: Advanced Micro Devices, Inc., Santa Clara, CA (US)

(21) Appl. No.: 18/374,263

(22) Filed: Sep. 28, 2023

(51) Int. Cl. G06F 9/50

(52) U.S. Cl. CPC G06F 9/5033; G06F 9/5038; G06F 9/5077

(57) ABSTRACT

In accordance with the described techniques, a host processor receives a task graph including tasks and indicating dependencies between the task graph. The host processor formats the task graph, in part, by sorting the tasks of the task graph in an order based on the dependencies between the tasks. Further, the host processor submits the formatted task graph to a scalable input/output virtualization (SIOV) device, which directs the SIOV device to process the tasks of the task graph based on the order.

### BACKGROUND

Virtualization is foundational to cloud computing, and enables creation of multiple independent execution environments (e.g., virtual machines and containers) in which applications and operating systems run. More specifically, input/output (I/O) virtualization involves creating multiple instances of a single physical I/O device (e.g., a network controller, a storage controller, or an accelerator), and exposing the multiple instances (e.g., virtual I/O devices) across multiple virtual machines, containers, or applications. Scalable input/output virtualization (SIOV) is an I/O virtualization paradigm that allows “direct-path” operations to be run directly on hardware, and “intercepted-path” operations to be emulated using software. SIOV provides improved resource sharing scalability, as compared to other I/O virtualization paradigms, e.g., Single Root I/O Virtualization (SR-IOV)

### BRIEF DESCRIPTION OF THE DRAWINGS

FIG. 1 is a block diagram of a non-limiting example system to implement task graph submission for SIOV devices.

FIG. 2 depicts a non-limiting example in which a host processor formats a task graph by partitioning the task graph into task groupings.

FIG. 3 depicts a non-limiting example in which a host processor formats a task graph by generating a data structure to be accessed by an SIOV device.

FIG. 4 depicts a procedure in an example implementation of task graph submission for SIOV devices.

### DETAILED DESCRIPTION

### Overview

A system includes a host processor communicatively coupled to an SIOV device. The SIOV device includes a command processor running scheduling firmware (e.g., a scheduler) and backend hardware resources. Broadly, the SIOV device is configured to receive submissions of work descriptors from multiple independent runtime software processes (e.g., virtual machines, containers, or applications) running on the host processor. Upon receiving the work descriptors, the SIOV device accepts (e.g., enqueues) the work descriptors into a shared work queue managed by the scheduler, and dispatches work described by the work descriptors for processing by the backend hardware resources based, in part, on an ordering of the work descriptors in the shared work queue.

In various execution scenarios, a program is received (e.g., by the host processor) as a task graph. Broadly, a task graph includes nodes that are tasks (e.g., processing kernels), and edges indicating dependencies between the tasks. Task graph processing improves computational efficiency and scalability of the system by dividing computational processes into fine-grained units of computation that are processable concurrently. Current SIOV designs, however, do not support tracking and preserving of dependencies between work descriptors. Accordingly, current SIOV designs do not support task graph processing, and also fail to realize the performance and scalability benefits thereof.

In accordance with the described techniques, the host processor receives a program as a task graph including tasks and dependencies between the tasks. During a pre-processing stage, the host processor formats the task graph in a way that reduces scheduling overhead imposed on the scheduler of the SIOV device. More specifically, the formatting of the task graph is performed by a compiler of the host processor (e.g., at compile time), or a runtime software process (e.g., a virtual machine, a container, or an application) that is submitting the task graph for processing by the SIOV device.

The formatting of the task graph takes any one or more of a variety of forms. In one example, the host processor formats the task graph by sorting the tasks in topological order, by which child tasks are ordered before parent tasks on which the child tasks depend. Additionally or alternatively, the host processor partitions the task graph into task groupings each including one or more tasks. Further, the host processor generates batch work descriptors for submission to the shared work queue, and the batch work descriptors point to addresses in memory where respective task groupings are stored. Additionally or alternatively, the host processor inserts barriers between tasks or between task groupings based on the dependencies of the task graph. Broadly, the barriers enforce the dependencies by causing the SIOV device to stall until the dependencies of one or more pending tasks are resolved. In at least one additional or alternative example, the host processor generates a data structure having the tasks arranged in the order and having barriers inserted between the tasks.

After formatting the task graph, the host processor (e.g., the runtime software process running on the host processor) submits the formatted task graph to the shared work queue. By way of example, the host processor submits the batch work descriptors pointing to the task groupings in memory and/or work descriptors which point to the data structure in memory. Upon encountering the work descriptors in the shared work queue, the SIOV device processes the tasks of the task graph in accordance with the formatting. For instance, the SIOV device dispatches tasks to the backend hardware resources by the task groupings, in the order, and while complying with the inserted barriers.

Thus, the described techniques enable efficient and lightweight task graph processing by upstreaming the formatting of the task graph to the host processor. Indeed, significant task scheduling overhead is potentially created for the command processor if, in contrast to the described techniques, the task graph was submitted to the SIOV device without any pre-processing performed. Further, bottlenecks in the system resulting therefrom can cause the SIOV device to reject work descriptors from being enqueued in the shared work queue, thereby hindering the scalability offered by SIOV. By leveraging the host processor for a large proportion of the scheduling and formatting work, the described techniques enable efficient execution of fine-grained task graphs without hindering the scalable resource sharing associated with the SIOV paradigm.

In some aspects, the techniques described herein relate to a system, comprising a scalable input/output virtualization (SIOV) device, and a host processor, configured to perform operations including receiving a task graph including tasks and indicating dependencies between the tasks, formatting the task graph, in part, by sorting the tasks of the task graph in an order based on the dependencies between the tasks, and submitting the formatted task graph to the SIOV device, thereby directing the SIOV device to process the tasks of the task graph based on the order.

In some aspects, the techniques described herein relate to a system, wherein sorting the tasks includes sorting the tasks of the task graph in the order using a topological sorting algorithm.

In some aspects, the techniques described herein relate to a system, wherein formatting the task graph includes partitioning the task graph into task groupings each including one or more tasks, sorting the tasks includes sorting the tasks in the order across the task groupings, and submitting the formatted task graph includes submitting, to a shared work queue of the SIOV device, one or more work descriptors identifying the task groupings.

In some aspects, the techniques described herein relate to a system, wherein a respective task grouping of the task groupings includes multiple tasks and one or more dependencies between the multiple tasks, and formatting the task graph includes inserting barriers in between the multiple tasks of the respective task grouping based on the one or more dependencies.

In some aspects, the techniques described herein relate to a system, wherein a first task grouping includes a first set of tasks that are independent of one another, and a second task grouping includes a second set of tasks having multiple dependencies on the first set of tasks of the first task grouping.

In some aspects, the techniques described herein relate to a system, wherein formatting the task graph includes replacing the multiple dependencies with a single dependency between the first task grouping and the second task grouping, the single dependency represented by one barrier directing the SIOV device to stall until the first set of tasks have completed before processing the second set of tasks.

In some aspects, the techniques described herein relate to a system, wherein formatting the task graph includes generating a data structure in which the tasks are arranged in the order, and submitting the formatted task graph includes communicating the data structure for storage in device memory of the SIOV device.

In some aspects, the techniques described herein relate to a system, wherein submitting the formatted task graph includes submitting a work descriptor including a pointer to the data structure in the device memory, the pointer directing the SIOV device to obtain one or more tasks for processing, in part, by accessing the data structure in the device memory.

In some aspects, the techniques described herein relate to a system, wherein formatting the task graph includes generating a work descriptor including one or more tasks and a pointer to one or more subsequent tasks in the order, the pointer directing the SIOV device to process the one or more subsequent tasks upon completion of the one or more tasks of the work descriptor.

In some aspects, the techniques described herein relate to a system, the operations further comprising generating one or more additional tasks after the SIOV device has begun processing the tasks of the task graph, the one or more additional tasks having one or more dependencies on the tasks of the formatted task graph, formatting the one or more additional tasks based on the one or more dependencies, and submitting the one or more additional tasks for processing by the SIOV device.

In some aspects, the techniques described herein relate to a system, wherein formatting the one or more additional tasks includes obtaining a list of completed tasks of the formatted task graph from the SIOV device, and inserting barriers in between the one or more additional tasks based on the one or more dependencies on uncompleted tasks of the formatted task graph that are absent from the list of completed tasks.

In some aspects, the techniques described herein relate to a system, wherein formatting the task graph includes generating a work descriptor that includes a pointer to a metadata object in memory, the pointer directing the SIOV device to obtain metadata from the metadata object and process the tasks of the task graph in accordance with the metadata.

In some aspects, the techniques described herein relate to a method, comprising receiving, by a host processor, a task graph including tasks and indicating dependencies between the tasks, sorting, by the host processor, the tasks of the task graph in an order based on the dependencies between the tasks, generating, by the host processor, batch work descriptors each including a pointer to a task grouping stored in memory of the host processor, and submitting, by the host processor, the batch work descriptors to a shared work queue of a scalable input/output virtualization (SIOV) device based on the order, the batch work descriptors directing the SIOV device to fetch and process respective task groupings.

In some aspects, the techniques described herein relate to a method, wherein sorting the tasks includes sorting the tasks of the task graph in the order using a topological sorting algorithm based on one or more priority factors.

In some aspects, the techniques described herein relate to a method, wherein generating the batch work descriptors includes inserting barriers in the respective task groupings based on the dependencies between the tasks in the respective task groupings.

In some aspects, the techniques described herein relate to a method, wherein a first task grouping includes a first set of tasks that are independent of one another, and a second task grouping includes a second set of tasks having multiple dependencies on the first set of tasks of the first task grouping.

In some aspects, the techniques described herein relate to a method, wherein generating the batch work descriptors includes replacing the multiple dependencies with a single dependency between the first task grouping and the second task grouping, the single dependency represented by one barrier directing the SIOV device to stall until the first set of tasks have completed before processing the second set of tasks.

In some aspects, the techniques described herein relate to a scalable input/output (SIOV) virtualization device, configured to receive a data structure from a host processor communicatively coupled to the SIOV device, the data structure including tasks of a task graph having been arranged in an order by the host processor based on dependencies between the tasks, store the data structure in device memory of the SIOV device, receive a work descriptor from the host processor, the work descriptor including a pointer to the data structure in the device memory, and process the tasks of the task graph in the order by accessing the data structure in the device memory based on the pointer.

In some aspects, the techniques described herein relate to an SIOV device, wherein the data structure is a priority queue in which the order is indicated by priorities assigned to the tasks, and to process the tasks, the SIOV device is configured to iteratively pop a task having a highest relative priority from the priority queue for processing.

In some aspects, the techniques described herein relate to an SIOV device, further comprising a shared work queue, wherein to process the tasks, the SIOV device is configured to enqueue the work descriptor in the shared work queue and process the tasks of the task graph based on the work descriptor being encountered in the shared work queue.

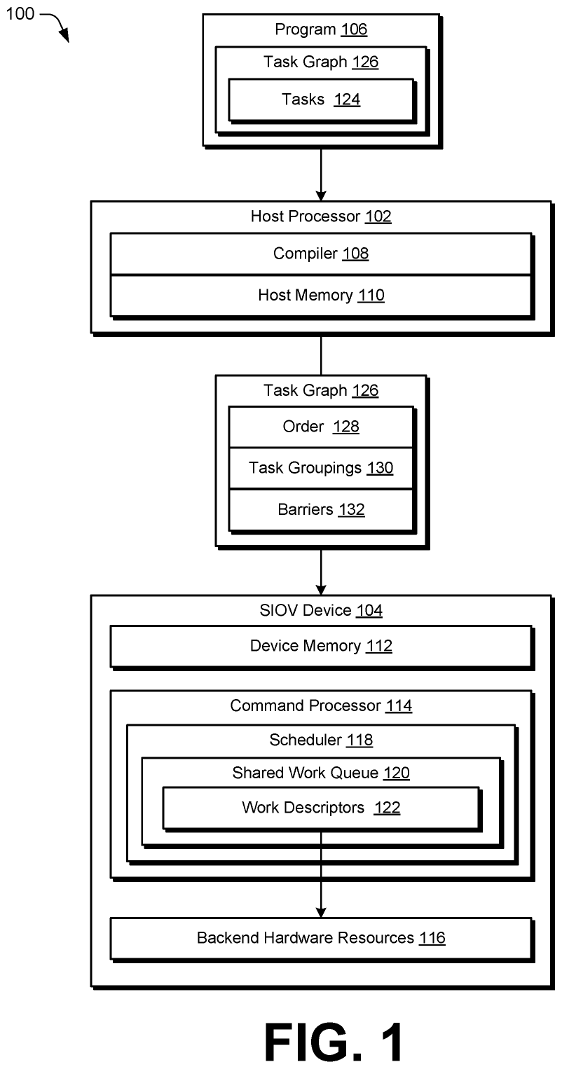

FIG. 1 is a block diagram of a non-limiting example system 100 to implement task graph submission for SIOV devices. Examples of devices in which the system 100 is implemented include, but are not limited to, supercomputers and/or computer clusters of high-performance computing (HPC) environments, servers, personal computers, laptops, desktops, game consoles, set top boxes, tablets, smartphones, mobile devices, virtual and/or augmented reality devices, wearables, medical devices, systems on chips, and other computing devices or systems.

In accordance with the described techniques, the system 100 includes a host processor 102 and a scalable input/output virtualization (SIOV) device 104, which are coupled to one another via a wired or wireless connection. Example wired connections include, but are not limited to, buses (e.g., a data bus), interconnects, traces, and planes. The host processor 102 is an electronic circuit that reads, translates, and executes operations of a program 106. Examples of the host processor 102 include, but are not limited to, a central processing unit (CPU), a field-programmable gate array (FGPA), and an application-specific integrated circuit (ASIC). As shown, the host processor 102 includes a compiler 108, which represents software that runs on the host processor 102 to translate (e.g., compile) the program 106 from a high-level source programming language into machine code, byte code, or some other low-level programming language that is executable by hardware components of the system 100.

The host processor 102 is additionally illustrated as including host memory 110, which is a device and/or system used to store information, such as for use by the host processor 102 and/or the SIOV device 104. In at least one example, the host memory 110 includes a cache system having one or more cache levels that are native to respective cores of the host processor 102, and one or more cache levels that are shared among multiple cores of the host processor 102. Additional or alternatively, the host memory 110 includes, but is not limited to including, any one or more of dynamic random-access memory (DRAM), scratchpad memory, and static random-access memory (SRAM).

The SIOV device 104 is an input/output (I/O) device configured in accordance with a protocol specified by the Scalable Input/Output Virtualization Technical Specification. Examples of the SIOV device 104 include network controllers, storage controllers, and accelerator devices, such as graphics processing units (GPUs), digital signal processors (DSPs), vision processing unit (VPUs), and cryptographic accelerators, to name just a few. Broadly, virtualization enables system software (e.g., hypervisors and/or container engines) to create multiple isolated execution environments, such as virtual machines or containers, in which applications and operating systems run. More specifically, I/O virtualization refers to the virtualization of I/O devices, thereby creating multiple instances of a single physical I/O device (e.g., referred to as virtual I/O devices) and exposing the multiple virtual I/O devices across multiple virtual machines, containers, or applications.

In accordance with SIOV, accesses between a virtual machine and an I/O device are facilitated via “direct-path” operations or “intercepted-path” operations. Direct-path operations are mapped directly to the underlying hardware of the I/O device, while intercepted-path operations are emulated using software, e.g., the virtual I/O devices. Furthermore, SIOV enables runtime software processes having different address domains (e.g., virtual machines, containers, and applications) to share hardware resources of the I/O device using different abstractions. For example, applications access hardware resources of an I/O device using system calls, while virtual machines and containers access hardware resources of an I/O device via virtual device interfaces. For these reasons, SIOV enables increased scalability and flexibility in comparison to other hardware-assisted I/O virtualization paradigms, such as single root I/O virtualization (SR-IOV).

As shown, the SIOV device 104 includes device memory 112, a command processor 114, and backend hardware resources 116, which are coupled to one another via wired or wireless connections. The device memory 112 is a device or system that is used to store information, such as for immediate use in the SIOV device 104, e.g., by the command processor 114 and/or the backend hardware resources 116. Similar to the host memory 110, examples of the device memory 112 include, but are not limited to including, any one or more of multi-level cache hierarchies, DRAM, scratchpad memory, and SRAM. In one or more examples, the command processor 114 is an integrated circuit, such as a CPU, embedded in a same computer chip that houses the SIOV device 104. Further, the command processor 114 is illustrated as including a scheduler 118, which in one or more instances, is implemented as firmware on the command processor 114.

The scheduler 118 is configured to manage a shared work queue 120, which is a work submission interface that is used concurrently by multiple independent runtime software processes running on the host processor 102, e.g., applications, virtual machines, and/or containers. For example, multiple independent runtime software processes submit work descriptors 122 to the shared work queue 120. In one or more implementations, the work descriptors 122 identify tasks 124 (e.g., processing kernels) that are to be processed by the SIOV device 104, e.g., using the backend hardware resources 116. In at least one example, the work descriptors 122 include one or more tasks 124 that are to be processed by the SIOV device 104. Additionally or alternatively, the work descriptors 122 include pointers to addresses in memory (e.g., the host memory 110 or the device memory 112) from which one or more tasks 124 are to be fetched and processed.

Notably, the backend hardware resources 116 are hardware components specific to the SIOV device 104. Depending on the type of I/O device implemented, for instance, the backend hardware resources 116 include command/status registers, on-device queues, references to in-memory queues, local memory on the SIOV device 104, and functional or compute units, to name just a few.

Upon receiving a work descriptor 122, the scheduler 118 is configured to accept or defer the work descriptor 122 based on any one or more of a variety of considerations, including but not limited to, capacity of the shared work queue 120, quality of service (QOS), and permission levels associated with the runtime software process submitting the work descriptor 122. In this context, “accepting” the work descriptor 122 means that the scheduler 118 enqueues the work descriptor 122 in the shared work queue 120 for subsequent dispatch to the backend hardware resources 116. In contrast, “deferring” the work descriptor 122 means that the scheduler 118 returns the work descriptor 122 to the runtime software process that submitted the work descriptor 122, directing the runtime software process to re-submit the work descriptor 122 at a later time.

In accordance with the described techniques, the host processor 102 receives the program 106 as a task graph 126, which includes nodes that are tasks 124 (e.g., processing kernels), and edges that indicate dependencies between the tasks 124 of the task graph 126. In order to properly execute a task graph 126, dependent tasks 124 (i.e., child tasks) are to be processed after tasks 124 (i.e., parent tasks) on which the dependent tasks 124 depend. In other words, a task 124 is processable after its dependencies are resolved. In general, task graph processing improves computational efficiency and scalability of the system 100 by dividing computational processes into fine-grained units of computation that are processable concurrently, e.g., by the backend hardware resources 116.

Current SIOV device designs support batch submission of work descriptors to the shared work queue 120. However, these designs do not account for dependencies between batches or between individual work descriptors. Current SIOV designs thus do not support task graph processing or applications that utilize task graphs 126, and also fail to realize the computational efficiency and scalability benefits of task graph processing.

Accordingly, techniques are described herein for task graph submission for SIOV devices. In accordance with the described techniques, the host processor 102 receives a task graph 126 including a plurality of tasks 124 and dependencies between the tasks 124. Rather than forwarding the task graph 126 directly to the SIOV device 104 for submission to the shared work queue 120, the host processor 102 initially formats the task graph 126, e.g., in a pre-processing stage. In at least one example, the formatting of the task graph 126 is performed by a runtime software process (e.g., a virtual machine, a container, or an application) that is submitting the task graph 126 for processing by the SIOV device 104. Additionally or alternatively, the formatting of the task graph 126 is performed by the compiler 108 of the host processor 102 at compile time, e.g., prior to execution of runtime software processes.

In one or more implementations, the host processor 102 formats the task graph 126 by sorting the tasks 124 of the task graph 126 in an order 128. In at least one example, the host processor 102 sorts the tasks 124 of the task graph 126 in topological order 128 using a topological sorting algorithm. Broadly, the topological sorting algorithm places parent tasks 124 before respective child tasks 124 depending therefrom in the order 128. Additionally or alternatively, the host processor 102 formats the task graph 126 by partitioning the tasks 124 of the task graph 126 into task groupings 130, each of which including one or more tasks 124 of the task graph 126. In various implementations, therefore, the tasks 124 are arranged in the order 128 across multiple task groupings 130.

Additionally or alternatively, the host processor 102 formats the task graph 126 by inserting barriers 132 between individual tasks 124 of the task graph 126 and/or between different task groupings 130. Broadly, a barrier 132 in front of a child task 124 or child task grouping 130 directs the scheduler 118 to stall until the parent tasks 124 of the child task 124 or child task grouping 130 have completed. For example, a barrier 132 in front of a child task 124 includes a counter value indicating a number of parent tasks 124 that the child task 124 depends from. The counter value is decremented when a respective parent task 124 completes, e.g., when the parent task 124 has been processed by the backend hardware resources 116. Further, the barrier 132 is satisfied when the counter value is decremented to zero, and thereafter, the next task 124 in the order 128 is ready for dispatch.

As shown, a runtime software process running on the host processor 102 submits the formatted task graph 126 to the shared work queue 120. To do so, in at least one example, the runtime software process submits work descriptors 122 pointing to addresses in memory (e.g., the host memory 110 or the device memory 112) where the task groupings 130 (e.g., having been arranged in the order 128 and having barriers 132 inserted therein) are stored. In accordance with the described techniques, the scheduler 118 accepts the work descriptors 122, and enqueues the work descriptors 122 in the shared work queue 120. Finally, the scheduler 118 processes the work descriptors 122 by dispatching the tasks 124 identified by the work descriptors 122 in accordance with the formatting performed. By way of example, the scheduler 118 dispatches the tasks 124 by task grouping 130, in the order 128, and while complying with the barriers 132.

Since the tasks are sorted in topological order, the next task 124 to process is the next task 124 in the order 128. Accordingly, the scheduler 118 does not use computational resources performing the sorting itself, or searching for tasks having resolved dependencies within the shared work queue 120. Furthermore, the task groupings 130 enable increased capacity on the shared work queue 120 because multiple tasks 124 are representable as a single entry in the shared work queue 120.

In addition, the task groupings 130 enable multiple individual dependencies to be representable as a single dependency relationship. For example, a child task grouping 130 includes tasks 124 having multiple dependencies on tasks 124 of a parent task grouping 130, and the multiple dependencies are representable by a single dependency relationship of the child task grouping 130 on the parent task grouping 130. Thus, the task groupings 130 further reduce the number of dependencies to track and reduce the number of barriers 132 to comply with. Finally, the barriers 132 enable the scheduler 118 to properly process the tasks 124 of the task graph 126 in accordance with the dependencies. Further, the described techniques rely on the host processor 102 to perform the work associated with barrier 132 insertion, which otherwise would be performed by the scheduler 118.

Accordingly, the described techniques enable efficient and lightweight task graph processing on the SIOV device 104 by upstreaming formatting of the task graph 126 to the host processor 102. Indeed, significant task scheduling overhead is potentially created for the command processor 114 if, in contrast to the described techniques, the task graph 126 was formatted by the scheduler 118. Bottlenecks resulting therefrom can cause the scheduler 118 to defer a larger proportion of work submissions, thereby reducing QoS and hindering the scalability of the SIOV device 104. By transferring a large proportion of the scheduling work to the host processor 102 (which typically includes more processing power than the command processor 114), the described techniques reduce scheduling overhead, and resultant bottlenecks. Accordingly, the described techniques improve overall computer performance since the SIOV device 104 is able to efficiently execute fine-grained task graphs 126 without hindering the scalability associated with SIOV.

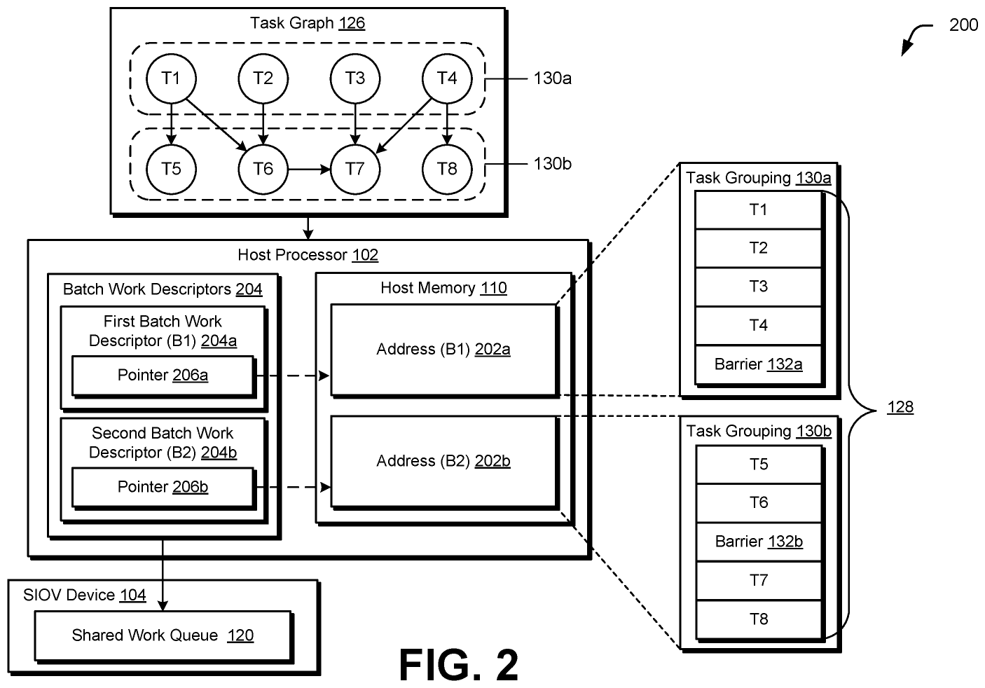

FIG. 2 depicts a non-limiting example 200 in which a host processor formats a task graph by partitioning the task graph into task groupings. As shown, the host processor 102 receives a task graph 126 including tasks 124 (e.g., T1, T2, T3, T4, T5, T6, T7, and T8) and dependencies between the tasks 124. Dependencies between the tasks 124 are illustrated in the task graph 126 as arrows, in which a direction of the arrow indicates the dependency relationship. For instance, T7 is dependent on T3, T4, and T6, while T6 is dependent on T1 and T2.

In accordance with the described techniques, the host processor 102 formats the task graph 126 prior to submitting the task graph 126 for processing by the SIOV device 104. To do so, the host processor 102 partitions the task graph 126 into task groupings 130a, 130b, and sorts the tasks 124 in the order 128 using the topological sorting algorithm. In this way, the task graph 126 is represented by task groupings 130a, 130b formed as linear arrays of individual tasks 124, and the individual tasks 124 are arranged in topological order 128 across multiple task groupings 130a, 130b.

In one or more implementations, the host processor 102 partitions the task graph 126 by including tasks 124 that are independent of one another in a first task grouping 130a. Further, the host processor 102 includes, in a second task grouping 130b, multiple tasks that depend from the tasks 124 in the first task grouping 130a, as depicted. By partitioning the tasks 124 in this way, the host processor 102 is able to replace multiple (e.g., six) dependencies between individual tasks in the different task groupings 130a, 130b with a single dependency relationship between the first task grouping 130a and the second task grouping 130b. To replace the multiple dependencies, the host processor 102 inserts a single barrier 132a at the end of the first task grouping 130a with a counter value of four. Here, the single barrier 132a directs the SIOV device 104 to stall until the four tasks 124 of the first task grouping 130 have completed before dispatching tasks 124 from the second task grouping 130b.

Additionally or alternatively, the host processor 102 partitions the task graph 126 by inserting one or more barriers 132 between individual tasks 124 within a respective task grouping 130. By way of example, the second task grouping 130b includes a dependency relationship T6 and T7. As part of formatting the task graph 126, the host processor 102 inserts a barrier 132b in the second task grouping 130b between T6 and T7, as depicted. Here, the barrier 132b directs the SIOV device 104 to stall until T6 has completed before dispatching T7.

Once the task groupings 130a, 130b are formed, the host processor 102 stores the task groupings 130a, 130b at respective addresses 202a, 202b in the host memory 110. Notably, the task groupings 130a, 130b include instructions for executing the tasks 124 within the groupings, data that is usable to execute the tasks 124 within the groupings, or both. Furthermore, the host processor 102 generates a first batch work descriptor 204a for the first task grouping 130a that includes a pointer 206a to the address 202a in host memory 110 where the first task grouping 130a is stored. Similarly, the host processor 102 generates a second batch work descriptor 204b for the second task grouping 130b that includes a pointer 206b to the address 202b in host memory 110 where the second task grouping 130b is stored.

As shown, the host processor 102 submits the batch work descriptors 204a, 204b to the shared work queue 120 of the SIOV device 104. The scheduler 118 of the SIOV device 104 receives the batch work descriptors 204a, 204b and accepts (e.g., enqueues) the batch work descriptors 204a, 204b into the shared work queue 120. Notably, the batch work descriptors 204a, 204b are submitted and enqueued in accordance with the order 128, e.g., the first batch work descriptor 204a is enqueued before the second batch work descriptor 204b in the shared work queue 120.

Upon encountering the first batch work descriptor 204a in the shared work queue 120, the scheduler 118 retrieves the first task grouping 130a from the address 202a indicated by the pointer 206a of the first batch work descriptor 204a. Further, the SIOV device 104 processes the first task grouping 130a in accordance with the formatting performed by the host processor 102. To do so, the scheduler 118 dispatches the four tasks 124 (e.g., T1, T2, T3, T4) of the first task grouping 130a to the backend hardware resources 116 for processing, and then stalls until the four tasks 124 have completed based on the barrier 132a.

Once the four tasks 124 of the first task grouping 130a have completed and the barrier 132a is satisfied, the scheduler 118 encounters the second task grouping 130b in the shared work queue 120. Given this, the scheduler 118 retrieves the second task grouping 130b from the address 202b indicated by the pointer 206b of the second batch work descriptor 204b. In response, the SIOV device 104 processes the second task grouping 130b in accordance with the formatting performed by the host processor 102. To do so, the scheduler 118 dispatches T5 and T6, and then stalls until T6 has completed based on the barrier 132b. After T6 has completed and the barrier 132b is satisfied, the scheduler 118 dispatches T7 and T8.

Although depicted as stored in host memory 110, it is to be appreciated that the task groupings 130 are storable in other memory locations without departing from the spirit or scope of the described techniques. In one alternative example, the host processor 102 communicates the task groupings 130a, 130 to the SIOV device 104 for storage in the device memory 112. In this example, the first batch work descriptor 204a includes a pointer to an address in the device memory 112 where the first task grouping 130a is stored, and the second batch work descriptor 204b includes a pointer to an additional address in device memory 112 where the second task grouping 130b is stored. Thus, when the batch work descriptors 204a, 204b are encountered in the shared work queue 120, the scheduler 118 retrieves the tasks 124 and the barriers 132 of respective task groupings 130 from the device memory 112, rather than the host memory 110.

In at least one alternative implementation, the host processor 102 inserts a pointer within a task grouping 130, and the pointer directs the SIOV device 104 to process one or more subsequent tasks in the order 128 upon completion of the tasks 124 in the task grouping 130. In an example of this alternative implementation, the host processor 102 generates and submits solely the first batch work descriptor 204a to the shared work queue 120, rather than bulk submitting the multiple batch work descriptors 204a, 204b. As part of formatting the task graph 126 in this alternative implementation, the host processor 102 inserts the second batch work descriptor 204b after the barrier 132a of the task grouping 130a. Here, the second batch work descriptor 204b directs the SIOV device 104 to fetch the second task grouping 130b from the address 202b, and process the tasks 124 and barriers 132 of the second task grouping 130b. By nesting the second batch work descriptor 204b within the first batch work descriptor 204a, the described techniques further increase capacity in the shared work queue 120. This is because solely the first batch work descriptor 204a occupies an entry in the shared work queue 120.

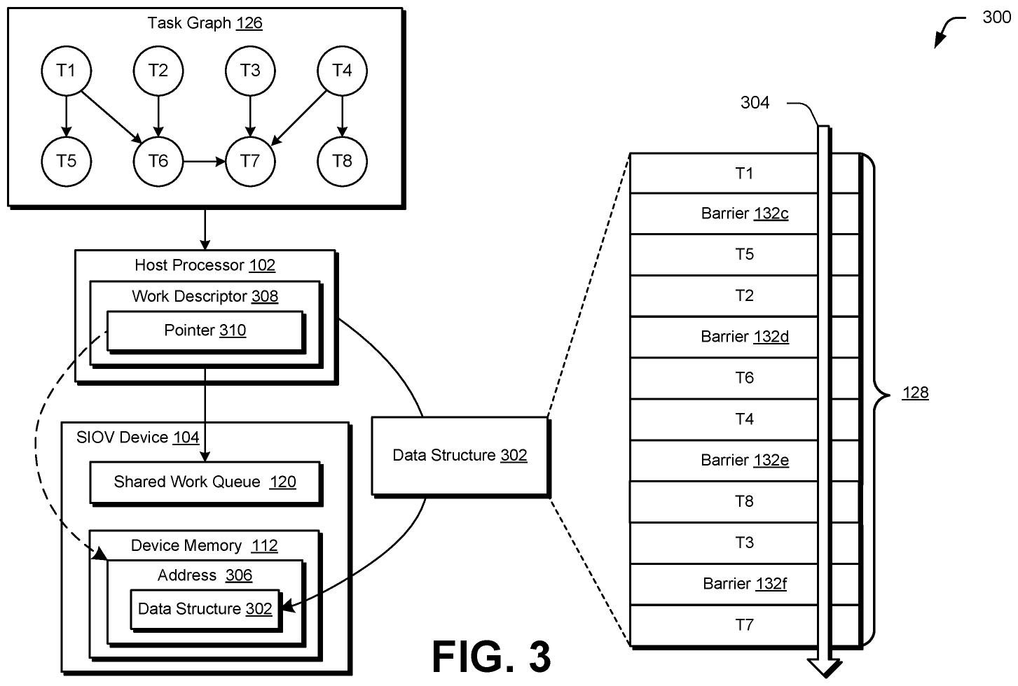

FIG. 3 depicts a non-limiting example 300 in which a host processor formats a task graph by generating a data structure to be accessed by an SIOV device. As shown, the host processor 102 receives the task graph 126 including tasks 124 and dependencies between the tasks 124. Further, the host processor 102 formats the task graph 126 by sorting the task graph 126 in the order 128 (e.g., using the topological sorting algorithm), as further discussed above. In the example 300, the host processor 102 additionally sorts the tasks 124 based on one or more additional priority factors, such as resource consumption associated with the tasks, a degree to which the tasks 124 are resource-constrained, and so on. Here, resources include divisible, usable parts of computer hardware, such as memory and communication channels. Further, a task is resource-constrained if a speed at which the task 124 is processed depends on an amount of a particular resource available on the SIOV device 104.

As part of sorting the tasks 124, the host processor 102 is configured to select a task 124 based on the one or more priority factors, and from among multiple tasks 124 that are capable of being placed at a certain position in the topological order 128. By way of example, four tasks (e.g., T1, T2, T3, T4) are capable of being placed at a first position in the order 128 because the four tasks have no dependencies. As shown, the host processor 102 places T1 at the first position, for example, based on T1 having a higher degree of resource consumption or being constrained to a higher degree by available resources than the other tasks. As a result, the tasks 124 in the example 300 are partially ordered based on one or more priority factors while maintaining topological order.

As previously mentioned, the host processor 102 additionally inserts barriers 132c, 132d, 132e, 132f into the ordered set of tasks 124 based on the dependencies that are to be preserved. By way of example, the barrier 132c has a counter value of one (e.g., based on T5's dependency on T1) and directs the SIOV device 104 to stall task dispatch until T1 has completed. Further, the barrier 132d has a counter value of two (e.g., based on T6's dependency on T1 and T2) and directs the SIOV device 104 to stall task dispatch until T1 and T2 have completed. Moreover the barrier 132e has a counter value of one (e.g., based on T8's dependency on T4) and directs the SIOV device 104 to stall task dispatch until T4 has completed. Finally, barrier 132f has a counter value of three (based on T7's dependency on T3, T4, and T6) and directs the SIOV device 104 to stall task dispatch until T3, T4, and T6 have completed.

In one or more implementations, the host processor 102 generates a data structure 302 including the tasks 124 having been arranged in the order 128, and including the barriers 132 having been inserted in between the tasks 124. Broadly, the data structure 302 stores data (e.g., the tasks 124 and the barriers 132) arranged in a particular manner so that the data is efficiently accessible and updatable. It should be noted that the tasks 124 within the data structure 302 include instructions for executing the tasks 124 and/or data that is usable to execute the tasks 124. In one example, the data structure 302 is a priority queue in which each element or entry in the priority queue is assigned a priority. In the illustrated example 300, the tasks 124 and barriers 132 are assigned descending priorities in the direction indicated by the depicted arrow 304.

Broadly, a priority queue is an array, linked list, heap, or binary tree structure, in which elements having a highest priority are popped from the priority queue efficiently, e.g., in O(1) time complexity for various priority queue structures. Although described herein as a priority queue, it is to be appreciated that the data structure 302 is formable as any suitable data structure (e.g., a sorted array), without departing from the spirit or scope of the described techniques.

As shown, the host processor 102 communicates the data structure 302 to the SIOV device 104, which receives and stores the data structure 302 at an address 306 in device memory 112. In addition, the host processor 102 generates a work descriptor 308 that includes a pointer 310 to the address 306 in the device memory 112 where the data structure 302 is stored. The host processor 102 then submits the work descriptor 308 to the shared work queue 120 of the SIOV device 104. Moreover, the scheduler 118 of the SIOV device 104 accepts (e.g., enqueues) the work descriptor 308 into the shared work queue 120.

Upon encountering the work descriptor 308 in the shared work queue 120, the work descriptor 308 directs the SIOV device 104 to access the data structure 302 at the address 306 in device memory 112 indicated by the pointer 310. In one or more examples, the work descriptor 308 directs the SIOV device to iteratively pop the task 124 or barrier 132 having a highest relative priority in the priority queue for processing. Here, “popping” a task 124 or barrier 132 means that the task 124 or the barrier 132 is obtained and subsequently deleted from the priority queue.

In the illustrated example, for instance, the scheduler 118 of the SIOV device 104 pops T1 from the priority queue and dispatches T1 to be processed by the backend hardware resources 116. Now that the barrier 132c has the highest priority in the priority queue, the SIOV device 104 pops the barrier 132c and processes the barrier 132c by stalling until T1 has completed. Once T1 completes and the barrier 132c is satisfied, T5 has the highest priority in the priority queue. Accordingly, the scheduler 118 pops T5 from the priority queue and dispatches T5 to be processed by the backend hardware resources 116. The scheduler 118 continues processing the tasks 124 and barriers 132 in this manner until the priority queue is drained.

Since entries in the priority queue are popped efficiently (e.g., in O (1) time complexity for various priority queue structures), the priority queue enables increased task retrieval speed, as compared to other task retrieval processes. Further, the described techniques enable increased capacity in the shared work queue 120 because one work descriptor 308 is submitted to the shared work queue 120 for processing the entire task graph 126.

Although depicted as stored in device memory 112, it is to be appreciated that the data structure 302 is storable in other memory locations without departing from the spirit or scope of the described techniques. In one alternative example, the data structure 302 is stored in the host memory 110. In this example, the work descriptor 308 includes a pointer to an address in the host memory 110 where the data structure 302 is stored. In this way, when the work descriptor 308 is encountered in the shared work queue 120, the scheduler 118 accesses the data structure 302 in the host memory 110, rather than the device memory 112.

In one or more scenarios, the host processor 102 generates one or more additional tasks 124 after the SIOV device 104 has begun processing the tasks 124 of the task graph 126, and the additional tasks 124 have dependencies on previously submitted tasks 124 of the task graph 126. In these scenarios, the host processor 102 is configured to query the SIOV device 104 for a list of completed tasks 124 of the task graph 126. Based on the list of completed tasks 124, the host processor 102 formats the one or more additional tasks based on the dependencies of the additional tasks 124 on the previously submitted tasks 124 of the task graph 126 that have not yet completed, e.g., the previously submitted tasks 124 that are absent from the list. Further, the host processor 102 submits the one or more additional tasks 124 to the SIOV device 104 to be processed in accordance with the formatting.

Consider an example in which an additional task, T9, is generated after the SIOV device 104 has begun processing the batch work descriptors 204 of FIG. 2. In this example, T9 depends on T7 and T3. Further, the host processor 102 obtains the list of completed tasks 124 indicating that the first task grouping 130a has already been processed, but the second task grouping 130b has not yet been processed. Accordingly, the host processor 102 formats T9 by inserting a barrier 132 in front of T9. While T9 has two dependencies on T7 and T3, one of the tasks (e.g., T3) has already completed. Given this, the barrier 132 inserted in front of T9 has a counter value of one. In accordance with the described techniques, the host processor 102 generates a task grouping 130 including the barrier 132 followed by the additional task (T9). Furthermore, the host processor 102 submits a batch work descriptor 204 to the shared work queue 120, and the batch work descriptor 204 includes a pointer to the task grouping 130 in memory.

Consider an additional example in which an additional task, T9, is generated after the SIOV device 104 has begun processing the work descriptor 308 of FIG. 3. In this example, T9 depends on T5 and T8. Further, the host processor 102 obtains the list of completed tasks 124 indicating that T1, T5, and T2 have completed. Given this, the host processor 102 formats T9 by inserting a barrier 132 in front of T9. While T9 has two dependencies on T5 and T8, one of the tasks (e.g., T5) has already completed. Given this, the barrier 132 inserted in front of T9 has a counter value of one. Here, the host processor 102 inserts the barrier 132 followed by the additional task, T9, into the data structure 302 at an appropriate location based on the dependencies. For example, the host processor 102 assigns a priority to the barrier 132 and T9 that is lower than T8 (e.g., based on T9's dependency on T8), and enqueues the barrier 132 and T9 in the priority queue.

In one or more implementations, the host processor 102 submits metadata to the shared work queue 120 alongside the formatted task graph 126. In addition to submitting the batch work descriptors 204a, 204b of FIG. 2, for example, the host processor 102 submits an additional work descriptor including a pointer to a metadata object maintained in memory, e.g., the host memory 110 or the device memory 112. In addition to submitting the work descriptor 308 of FIG. 3, for example, the host processor 102 submits an additional work descriptor including a pointer to one or more entries in the data structure 302. In this example, the one or more entries store metadata associated with the task graph 126.

Upon encountering the additional work descriptor in the shared work queue 120, the SIOV device 104 reads the metadata based on the pointer, e.g., from the metadata object in memory or from the one or more entries in the data structure 302. In various implementations, the metadata associated with the task graph 126 describes a total number of tasks 124 in the task graph 126, an indication of how the task graph 126 is partitioned into task groupings 130, a number of barriers 132 inserted in the task graph 126, a degree of anticipated resource usage (e.g., of the backend hardware resources 116) by the tasks 124 of the task graph 126, and so on. The SIOV device 104 is configured to process the tasks 124 of the task graph 126 based on the metadata. In an example in which the metadata indicates a high degree of resource usage, the SIOV device 104 allocates a larger proportion of the backend hardware resources 116 to the software process submitting the task graph 126, e.g., as compared to other software processes accessing the SIOV device 104.

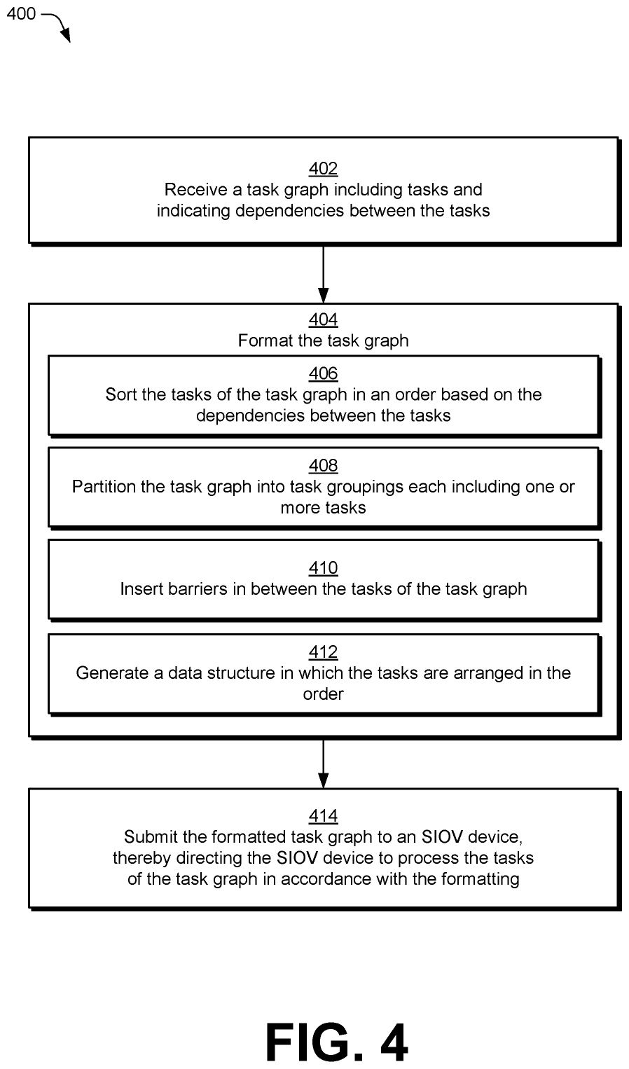

FIG. 4 depicts a procedure 400 in an example implementation of task graph submission for SIOV devices. In the procedure 400, a task graph is received that includes tasks and indicates dependencies between the tasks (block 402). By way of example, the host processor 102 receives, as part of a program 106, a task graph 126 including tasks 124 and dependencies between the tasks 124.

The task graph is formatted (block 404), and as part of the formatting, the tasks of the task graph are sorted in an order based on the dependencies between the tasks (block 406). By way of example, the host processor 102 formats the task graph 126. In particular, the compiler 108 or a runtime software process running on the host processor 102 performs the formatting. As part of this, the host processor 102 sorts the tasks 124 of the task graph 126 in an order 128 using a topological sorting algorithm.

In one or more implementations, the task graph is partitioned into task groupings each including one or more tasks (block 408). For instance, the host processor 102 partitions the tasks 124, having been arranged in the order 128, into task groupings 130. As a result, the tasks are arranged in the order 128 across multiple task groupings 130. In at least one example, the tasks 124 are partitioned by “level” in the task graph 126. This means that each task grouping 130 includes one or more tasks that are independent of one another, and the tasks in each respective subsequent task grouping 130 are solely dependent on tasks in a respective previous task grouping 130.

Additionally or alternatively, barriers are inserted in between the tasks of the task graph (block 410). By way of example, the host processor 102 inserts barriers in between the tasks 124 of the task graph 126 based on the dependencies between the tasks 124. Broadly, barriers 132 direct the SIOV device 104 to stall dispatch of tasks 124 (e.g., to the backend hardware resources 116) until one or more previously dispatched tasks 124 have completed in order to preserve the dependencies. In some implementations (e.g., when the tasks 124 are partitioned by level in the task graph 126), a first task grouping 130a includes a first set of tasks that are independent of one another, and a second task grouping 130b includes a second set of tasks having multiple dependencies on the first set of tasks. In these implementations, the host processor 102 replaces the multiple dependencies with a single dependency relationship between the first task grouping 130a and the second task grouping 130b, e.g., represented as a barrier 132a between the first task grouping 130a and the second task grouping 130b.

In one or more implementations, a data structure is generated in which the tasks are arranged in the order (block 412). For instance, the host processor 102 generates a data structure 302, such as a priority queue or a sorted array. In the data structure 302, the tasks 124 have been arranged in the order 128, the tasks 124 have been partitioned into task groupings 130, and/or the barriers 132 have been inserted in between the tasks 124, in accordance with the described techniques.

The formatted task graph is submitted to an SIOV device, thereby directing the SIOV device to process the tasks of the task graph in accordance with the formatting (block 414). By way of example, a software process running on the host processor 102 submits the formatted task graph 126 to the SIOV device 104. To do so, in one or more implementations, the host processor 102 submits work descriptors 122 to the shared work queue 120 including or identifying the tasks 124. By way of example, the host processor 102 submits one or more batch work descriptors 204, each of which including a pointer to an address in memory where a respective task grouping 130 is stored. Upon encountering a batch work descriptor 204 in the shared work queue 120, the scheduler 118 retrieves the task grouping 130 based on the pointer. In addition, the SIOV device 104 processes the task grouping 130 by dispatching tasks 124 to the backend hardware resources 116 for processing while complying with the barriers 132 inserted.

Additionally or alternatively, the host processor 102 submits the formatted task graph 126 by communicating the data structure 302 for storage in device memory 112 of the SIOV device 104. Further, the host processor 102 submits a work descriptor 308 including a pointer to an address in device memory 112 where the data structure 302 is stored. Upon encountering the work descriptor 308 in the shared work queue 120, the SIOV device 104 is directed to process the tasks 124 of the task graph 126 by accessing the data structure 302 at the address in device memory 112. In examples in which the data structure 302 is a priority queue, for instance, the work descriptor 308 directs the SIOV device to iteratively pop the task 124 or barrier 132 having a highest relative priority in the priority queue for processing.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the host processor 102, the SIOV device 104, the compiler 108, the host memory 110, the device memory 112, the command processor 114, the backend hardware resources 116, and the scheduler 118) are implemented in any of a variety of different manners such as hardware circuitry, software or firmware executing on a programmable processor, or any combination of two or more of hardware, software, and firmware. The methods provided are implemented in any of a variety of devices, such as a general purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A system, comprising:
a scalable input/output virtualization (SIOV) device; and
a host processor, configured to perform operations including:
receiving a task graph including tasks and indicating dependencies between the tasks;
formatting the task graph, in part, by sorting the tasks of the task graph in an order based on the dependencies between the tasks; and
submitting the formatted task graph to the SIOV device, thereby directing the SIOV device to process the tasks of the task graph based on the order.

2. The system of claim 1, wherein sorting the tasks includes sorting the tasks of the task graph in the order using a topological sorting algorithm.

3. The system of claim 1, wherein formatting the task graph includes partitioning the task graph into task groupings each including one or more tasks, sorting the tasks includes sorting the tasks in the order across the task groupings, and submitting the formatted task graph includes submitting, to a shared work queue of the SIOV device, one or more work descriptors identifying the task groupings.

4. The system of claim 3, wherein a respective task grouping of the task groupings includes multiple tasks and one or more dependencies between the multiple tasks, and formatting the task graph includes inserting barriers in between the multiple tasks of the respective task grouping based on the one or more dependencies.

5. The system of claim 3, wherein a first task grouping includes a first set of tasks that are independent of one another, and a second task grouping includes a second set of tasks having multiple dependencies on the first set of tasks of the first task grouping.

6. The system of claim 5, wherein formatting the task graph includes replacing the multiple dependencies with a single dependency between the first task grouping and the second task grouping, the single dependency represented by one barrier directing the SIOV device to stall until the first set of tasks have completed before processing the second set of tasks.

7. The system of claim 1, wherein formatting the task graph includes generating a data structure in which the tasks are arranged in the order, and submitting the formatted task graph includes communicating the data structure for storage in device memory of the SIOV device.

8. The system of claim 7, wherein submitting the formatted task graph includes submitting a work descriptor including a pointer to the data structure in the device memory, the pointer directing the SIOV device to obtain one or more tasks for processing, in part, by accessing the data structure in the device memory.

9. The system of claim 1, wherein formatting the task graph includes generating a work descriptor including one or more tasks and a pointer to one or more subsequent tasks in the order, the pointer directing the SIOV device to process the one or more subsequent tasks upon completion of the one or more tasks of the work descriptor.

10. The system of claim 1, the operations further comprising:
generating one or more additional tasks after the SIOV device has begun processing the tasks of the task graph, the one or more additional tasks having one or more dependencies on the tasks of the formatted task graph;
formatting the one or more additional tasks based on the one or more dependencies; and
submitting the one or more additional tasks for processing by the SIOV device.

11. The system of claim 10, wherein formatting the one or more additional tasks includes:
obtaining a list of completed tasks of the formatted task graph from the SIOV device; and
inserting barriers in between the one or more additional tasks based on the one or more dependencies on uncompleted tasks of the formatted task graph that are absent from the list of completed tasks.

12. The system of claim 1, wherein formatting the task graph includes generating a work descriptor that includes a pointer to a metadata object in memory, the pointer directing the SIOV device to obtain metadata from the metadata object and process the tasks of the task graph in accordance with the metadata.

13. A method, comprising:
receiving, by a host processor, a task graph including tasks and indicating dependencies between the tasks;
sorting, by the host processor, the tasks of the task graph in an order based on the dependencies between the tasks;
generating, by the host processor, batch work descriptors each including a pointer to a task grouping stored in memory of the host processor; and
submitting, by the host processor, the batch work descriptors to a shared work queue of a scalable input/output virtualization (SIOV) device based on the order, the batch work descriptors directing the SIOV device to fetch and process respective task groupings.

14. The method of claim 13, wherein sorting the tasks includes sorting the tasks of the task graph in the order using a topological sorting algorithm based on one or more priority factors.

15. The method of claim 13, wherein generating the batch work descriptors includes inserting barriers in the respective task groupings based on the dependencies between the tasks in the respective task groupings.

16. The method of claim 13, wherein a first task grouping includes a first set of tasks that are independent of one another, and a second task grouping includes a second set of tasks having multiple dependencies on the first set of tasks of the first task grouping.

17. The method of claim 16, wherein generating the batch work descriptors includes replacing the multiple dependencies with a single dependency between the first task grouping and the second task grouping, the single dependency represented by one barrier directing the SIOV device to stall until the first set of tasks have completed before processing the second set of tasks.

18. A scalable input/output virtualization (SIOV) device, configured to:
receive a data structure from a host processor communicatively coupled to the SIOV device, the data structure including tasks of a task graph having been arranged in an order by the host processor based on dependencies between the tasks;
store the data structure in device memory of the SIOV device;
receive a work descriptor from the host processor, the work descriptor including a pointer to the data structure in the device memory; and
process the tasks of the task graph in the order by accessing the data structure in the device memory based on the pointer.

19. The SIOV device of claim 18, wherein the data structure is a priority queue in which the order is indicated by priorities assigned to the tasks, and to process the tasks, the SIOV device is configured to iteratively pop a task having a highest relative priority from the priority queue for processing.

20. The SIOV device of claim 18, further comprising a shared work queue, wherein to process the tasks, the SIOV device is configured to enqueue the work descriptor in the shared work queue and process the tasks of the task graph based on the work descriptor being encountered in the shared work queue.
